(19) United States
(12) Patent Application Publication
(10) Pub. No.: US 2026/0116174 A1
(43) Pub. Date: Apr. 30, 2026

(54) ELECTRIC DRIVE MODULE INTERMEDIATE BRACKET FOR AN ELECTRIFIED VEHICLE

(71) Applicant: FCA US LLC, Auburn Hills, MI (US)

(72) Inventors: Abhishek Paul, Auburn Hills, MI (US); Bramha Pradhy, Auburn Hills, MI (US); Syed Haider, Auburn Hills, MI (US)

(21) Appl. No.: 18/926,567

(22) Filed: Oct. 25, 2024

(51) Int. Cl. B60K 6/40

(52) U.S. Cl. CPC B60K 6/40

(57) ABSTRACT

A bracket assembly for an electric drive module having a drive module includes a first intermediate bracket coupled to a first side of the housing a second intermediate bracket disposed on a second side of the housing, a first cross member coupling the first intermediate bracket and the second intermediate bracket and a second cross member coupling the first intermediate bracket and the second intermediate bracket. The first intermediate bracket and the second intermediate bracket are configured to some extent similarly. The brackets include a planar base, a top mounting extension perpendicular to the base in a first direction, the top mounting extension comprising a cylindrical extension extending therefrom. A bottom mounting extension perpendicular to the base in the first direction. A plurality of housing mounts extends perpendicular to the base. A plurality of ribs couples the plurality of housing mounts the top mounting extension and the bottom mounting extension.

### FIELD

The present disclosure relates to electric drive modules for an electric vehicle and, in particular, to a bracket to secure the electric drive module within the electric vehicle.

### BACKGROUND

This section provides background information related to the present disclosure which is not necessarily prior art.

Electric vehicles comprise an electrified powertrain that comprise may comprises individual components such as a motor, transmission and power electronics. In some vehicles, an electric drive module (EDM) is a system with the components housed together. The electric drive modules contain an electric motor, a transmission and power electronics coupled together and mounted together in the vehicle. The electric drive module assembly is a convenient way to provide the motive force to a vehicle.

One problem with electric modules is that road and EDM noise is persistent within the vehicle. Reducing the amount of EDM noise within the vehicle is important.

### SUMMARY

This section provides a general summary of the disclosure, and is not a comprehensive disclosure of its full scope or all of its features.

In an example of the present disclosure, a bracket assembly for an electric drive module having a drive module includes a first intermediate bracket coupled to a first side of the housing a second intermediate bracket disposed on a second side of the housing, a first cross member coupling the first intermediate bracket and the second intermediate bracket and a second cross member coupling the first intermediate bracket and the second intermediate bracket. The first intermediate bracket and the second intermediate bracket are configured to some extent similarly. The brackets include a planar base, a top mounting extension perpendicular to the base in a first direction, the top mounting extension comprising a cylindrical extension extending therefrom. A bottom mounting extension perpendicular to the base in the first direction. A plurality of housing mounts extends perpendicular to the base. A plurality of ribs couples the plurality of housing mounts the top mounting extension and the bottom mounting extension.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a high level block diagram of a high voltage cable layout for a vehicle.

FIG. 2 is a perspective view of the bracket assembly 30.

FIG. 3 is a front view of the mounting bracket assembly 30.

FIG. 4 is a perspective view of the electric drive module.

FIGS. 5A and 5B are perspective views of the intermediate bracket and the cradle.

FIGS. 6A and 6B are perspective views of the intermediate bracket, the electric drive module and the cradle.

FIGS. 7A and 7B are perspective views of the intermediate bracket and the electronic drive module.

FIG. 8A is a rear perspective view of the right intermediate bracket.

FIG. 8B is a front perspective view of the right intermediate bracket.

FIG. 8C is a front view of the right intermediate bracket.

FIG. 8D is a back view of the right intermediate bracket.

FIG. 8E is a right side view of the right intermediate bracket.

FIG. 8F is a left view of the right intermediate bracket.

FIG. 8G is a top view of the right intermediate bracket.

FIG. 8H is a bottom view of the right intermediate bracket.

FIG. 9A is a rear perspective view of the left intermediate bracket.

FIG. 9B is a front perspective view of the left intermediate bracket.

FIG. 9C is a front view of the left intermediate bracket.

FIG. 9D is a back view of the left intermediate bracket.

FIG. 9E is a right side view of the left intermediate bracket.

FIG. 9F is a left view of the left intermediate bracket.

FIG. 9G is a top view of the left intermediate bracket.

FIG. 9H is a bottom view of the left intermediate bracket.

### DETAILED DESCRIPTION

Example embodiments will now be described more fully with reference to the accompanying drawings.

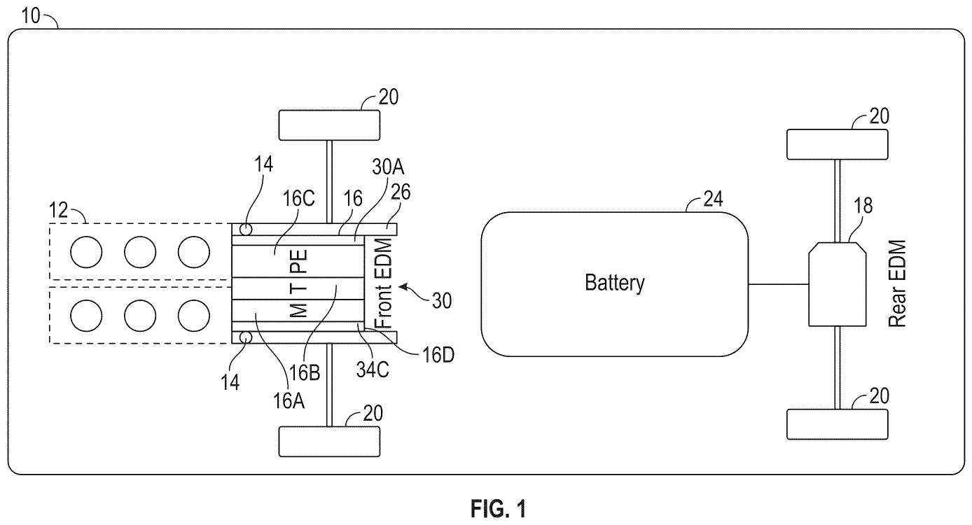

Referring now to FIG. 1, a high level block diagram of a layout for an electrified vehicle 10 is depicted. The vehicle 10 may be designed to be a battery electric vehicle or vehicle with an internal combustion engine 12. The engine 12 is mounted to the vehicle 10 by engine mounting locations 14 with engine mounts, two of which are shown. The present system is exclusively for a battery electric vehicle 10, but the engine 12 is not used. However, the mounting locations 14 are used to mount a front electric drive module (EDM) 16. In a non-dual purpose vehicle 10, another mounting location may be designed therein. The electric drive module 16 has a motor 16A, a transmission 16B and power electronics 16C. The motor 16A and the transmission 16B may be mounted in a common housing 16D. A rear electric drive module (EDM) 18 may also be used by the system. The front electric drive module 16 and rear electric drive module 18 are connected to and provide motive power to the wheels 20. More than two EDMs such as two rear EDMs, two front EDMs or two front EDMs and two rear EDMs are other examples.

A battery 24 through the power electronics 16C drives the motors 16A to drive the wheels/tire 20.

A cradle 26 may also be part of the vehicle 10. The cradle 26 may be disposed under a bracket assembly 30 and is used to support the bracket assembly 30. The mounting location 14 is located above the bracket assembly 30. Further details of the mounted bracket are set forth below.

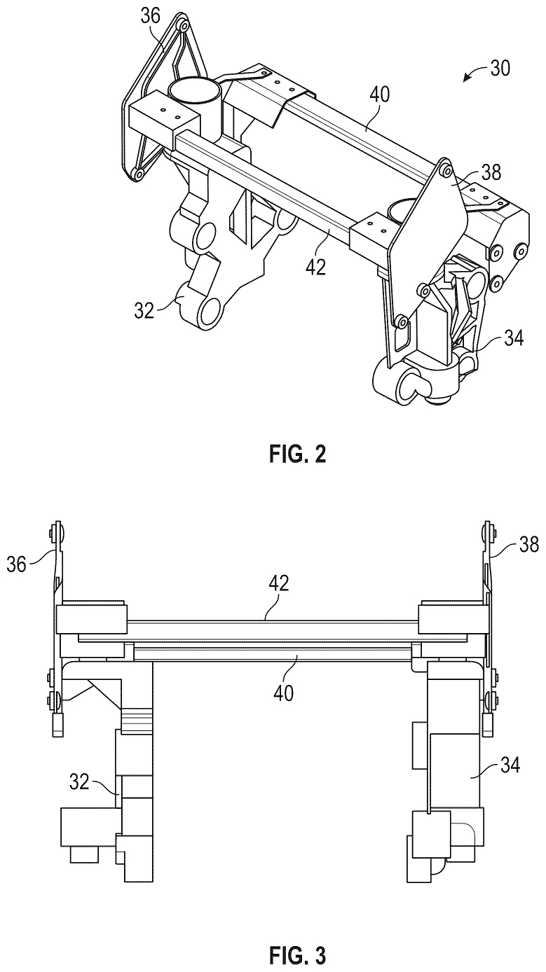

Referring now to FIGS. 2 and 3, the bracket assembly 30 is illustrated in further detail without being mounted to the electric drive module (EDM) 16. The bracket assembly 30 includes a right intermediate bracket 32 and a left intermediate bracket 34. The terms right and left are used relative to the forward direction of the vehicle 10. The right intermediate bracket 32 has an upper attachment bracket 36 coupled thereto. The left intermediate bracket 34 has a second attachment bracket 38 coupled thereto. The upper attachment brackets 36, 38 have a rear cross member 40 coupled therebetween. The upper attachment brackets 36, 38 have respective upper mounts 44, 46 formed therein. The upper mounts 44, 46 may be coupled to the mounting locations 14 described above.

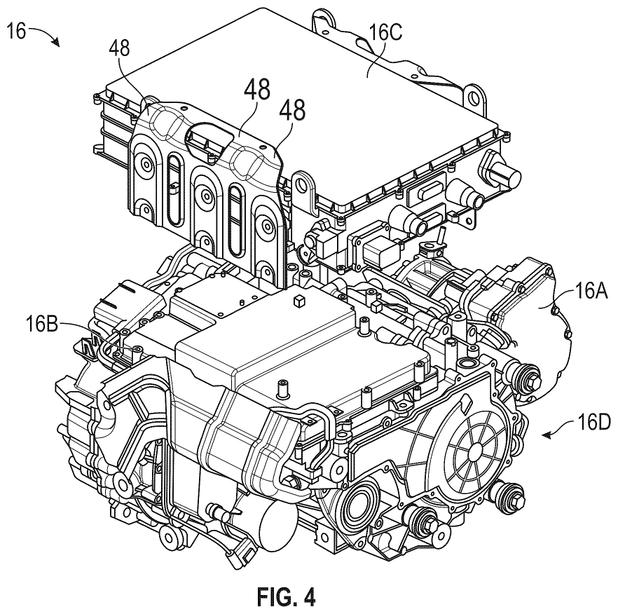

Referring now to FIG. 4, the electric drive module 16 is illustrated in further detail. The power electronics 16C are positioned above the housing 16D that has the motor 16A and the transmission 16B. As will be illustrated below, the power electronics 16C has brackets 48 that are used to couple the power electronics 16C to the cross members 40, 42.

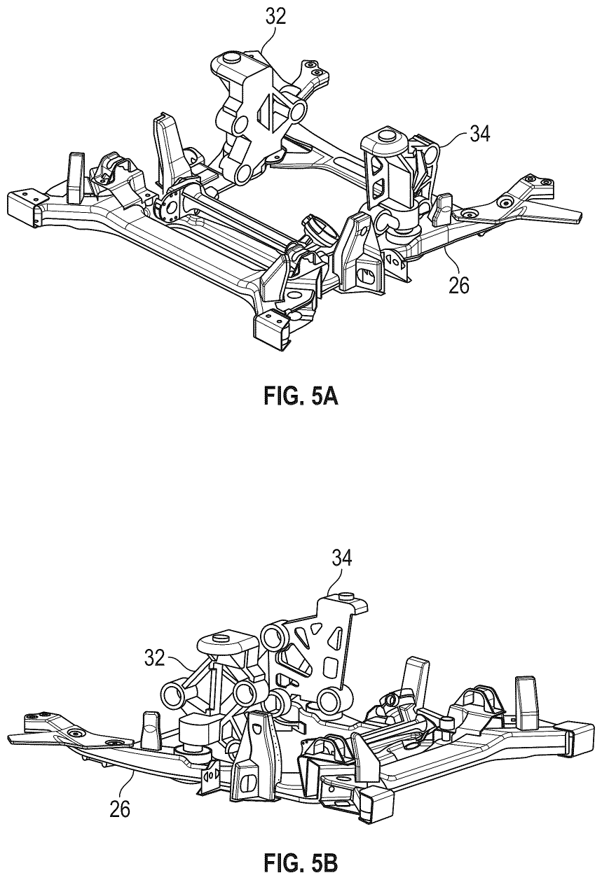

Referring now to FIGS. 5A and 5B, the right intermediate bracket 32 and the left intermediate bracket 34 are shown coupled to the cradle 26 of the vehicle. The bottom of each of the intermediate brackets 32, 34 are coupled at a mounting extension as described in greater detail below.

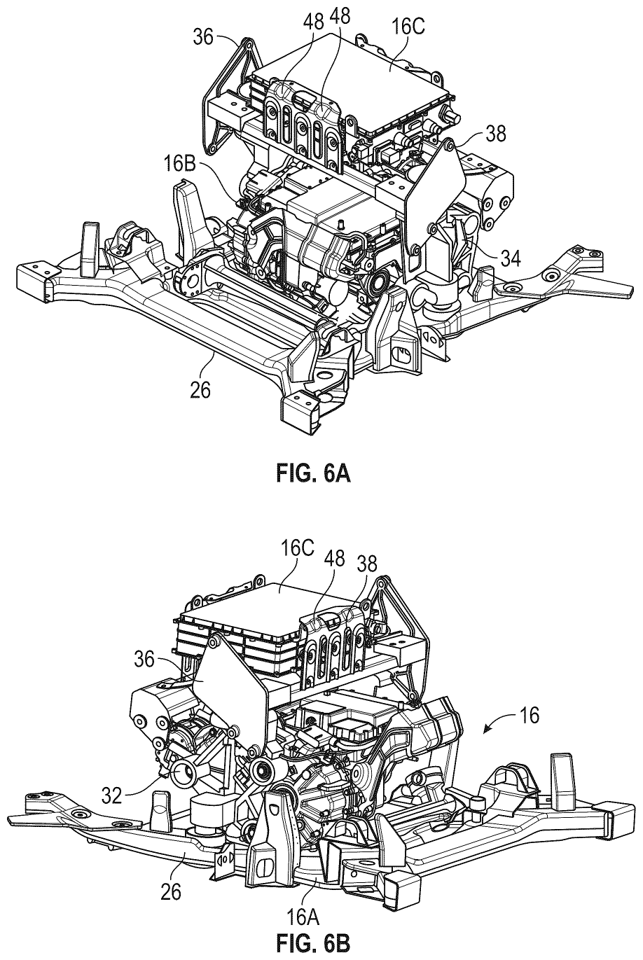

Referring now to FIGS. 6A and 6B, the cradle 26 is illustrated with the electric drive module 16, the components thereof and the intermediate brackets 32, 34 along with the upper attachment brackets 36, 38.

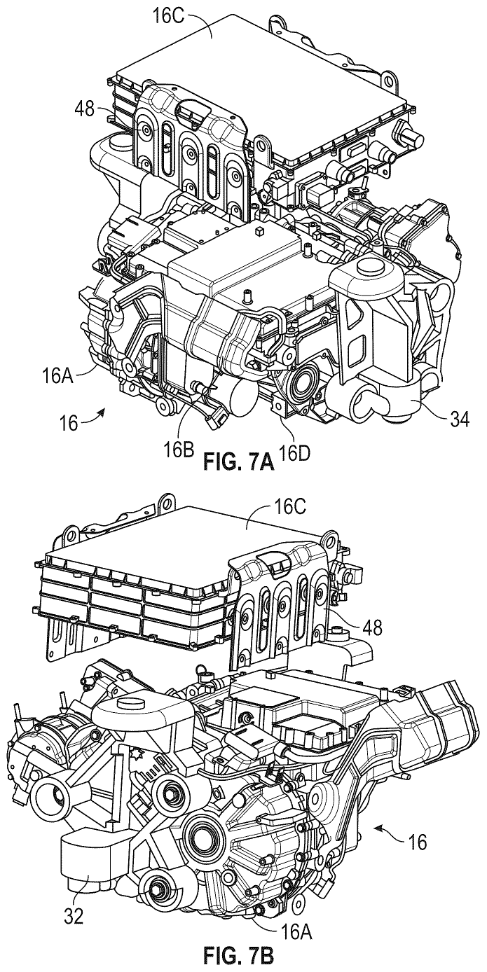

Referring now to FIGS. 7A and 7B, the right intermediate bracket 32 and the left intermediate bracket 34 are illustrated coupled to the housing 16D of the electric drive module 16.

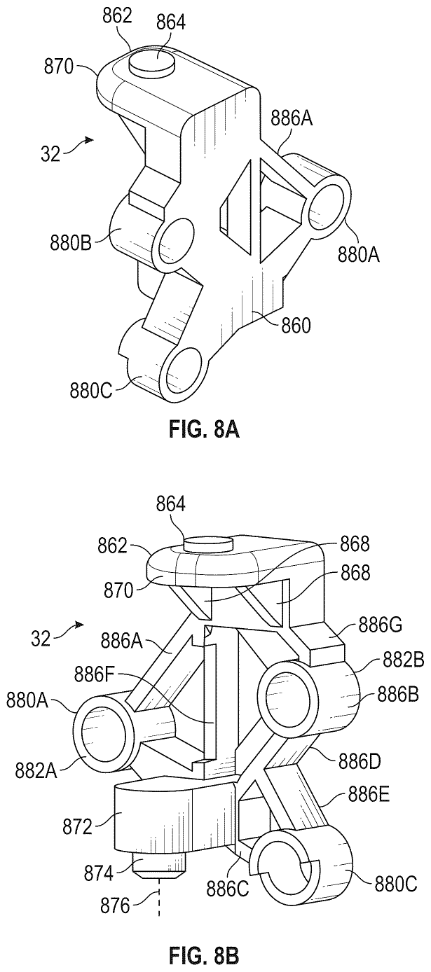

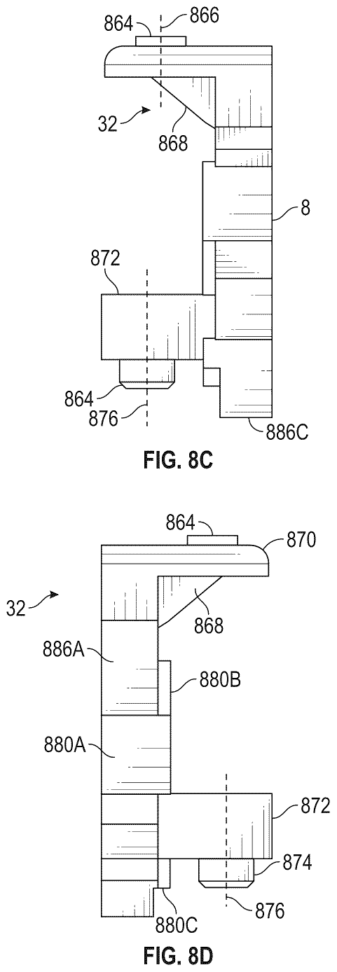

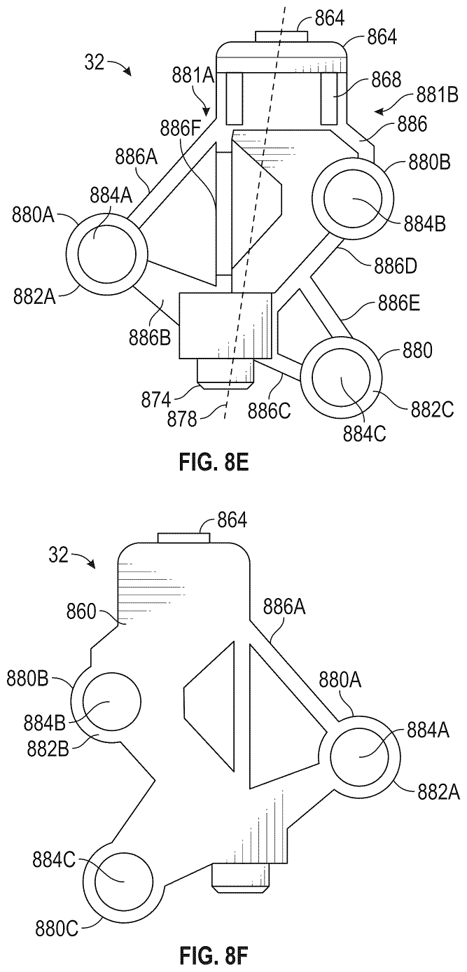

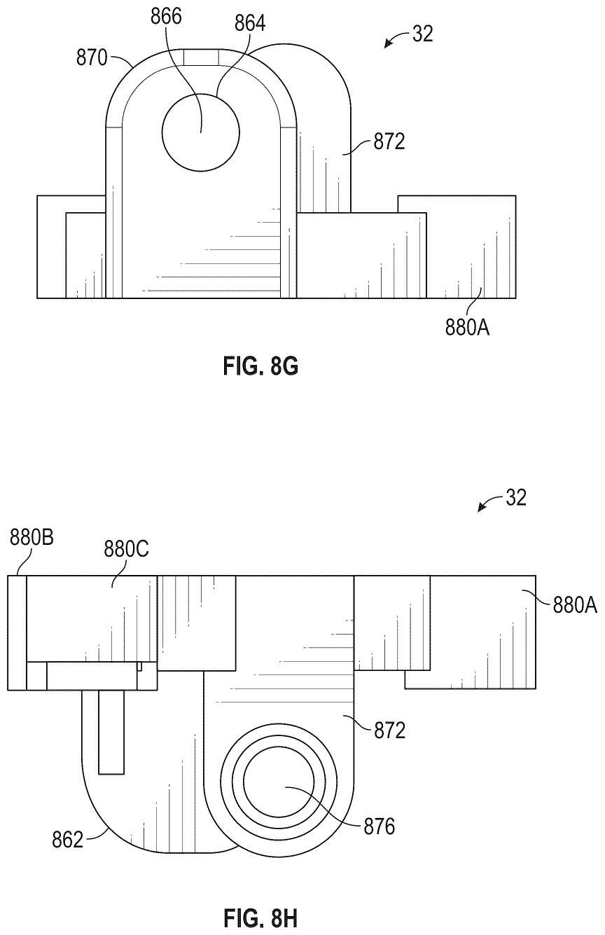

Referring now to FIGS. 8A-8H, various views of the right intermediate bracket 32 are illustrated. A planar base 860 is illustrated. The planar base 860 may be made of continuous material or may have portions that are cut out. From an engineering standpoint, having more of the planar base 860 cut out reduces the amount of weight of the intermediate bracket. However, enough of the planar base 860 is retained to provide strength based upon engineering analysis. The right intermediate bracket 32 has a top mounting extension 862. The top mounting extension 862 has a cylindrical extension 864 extending upwards therefrom. That is, in a vehicle setting, the extensions 864 may be in a horizontal in direction. The cylindrical extensions 864 have a longitudinal axis 866. The extensions 864 extend in a direction perpendicular to the general planar base 860. A pair of angular supports 868 extend diagonally between the extension 864 and the planar base 860. The supports 868 extend on a 45° angle to angularly support the extensions 864. The extensions 864 are generally planar but have a curved or semi-circular edge.

The extension 864 extends to couple to one of the upper attachment bracket 36.

A lower mounting extension 872 has a lower extension 874 that is cylindrical and extends outward from the lower mounting extension 872. The lower mounting extension 872 extends in the same direction as the upper mounting extension 864. The lower extension 874 has an axis 876. The upper extension 864 and the lower extension 874 are parallel to each other and are both perpendicular to the planar base 860. The axis 876 is not colinear with or not aligned with the axis 866.

A dividing line 878 is an imaginary line that extends from the upper extension 864 to the lower extension 874 and forms two lateral sides of the bracket 32; a first lateral side 881A and a second lateral side 881B. The right intermediate bracket 32 has three housing mounts 880A, 880B and 880C. The housing mount 880A is disposed on the first side lateral side 881A of the dividing line 878. The housing mounts 880B and 880C are located on the second lateral side 881B of the dividing line 878 from the housing mount 880A. Each of the housing mounts 880A-880C are defined by cylindrical walls 882A, 882B and 882C, respectively. The cylindrical walls 882 have respective axes 884A, 884B and 884C. The axes 884A-884C are normal to or perpendicular from the planar base 860. The housing mounts 880A-880C are used for coupling to the housing 16D of the electric drive module 16.

As is best illustrated in FIGS. 8B and 8E, a plurality of ribs is used to strengthen and reinforce the right intermediate bracket 32. A first rib 886A extends between the housing mount 880A and the portion of the planar base 860 below the top mounting extension 862.

A second rib extends from the housing mounting 880A and the cylindrical wall 882B to the area directly adjacent to the lower mounting extension 872.

A third rib 886C extends between the housing 880B and the lower mounting extension 872. In particular, the cylindrical wall 882B and the lower mounting extension 872 have a rib therebetween.

A fourth rib 886D couples the cylindrical wall 882B of the housing 880B to the lower mounting extension 872. A fifth rib 886E extends between the fourth rib 886D and the cylindrical wall 882C of the housing mount 880C. A sixth rib 886F extends between the top mounting extension 862 and the lower mounting extension 872. All of the ribs 886A-886B extend outward from the planar base 860. The thickness and number of ribs may vary depending on the design. However, each of the housing mounts 880A-880C have ribs extending therefrom. A seventh rib 880G extends between the cylindrical wall 882B and the area at or near the top mounting extension 862.

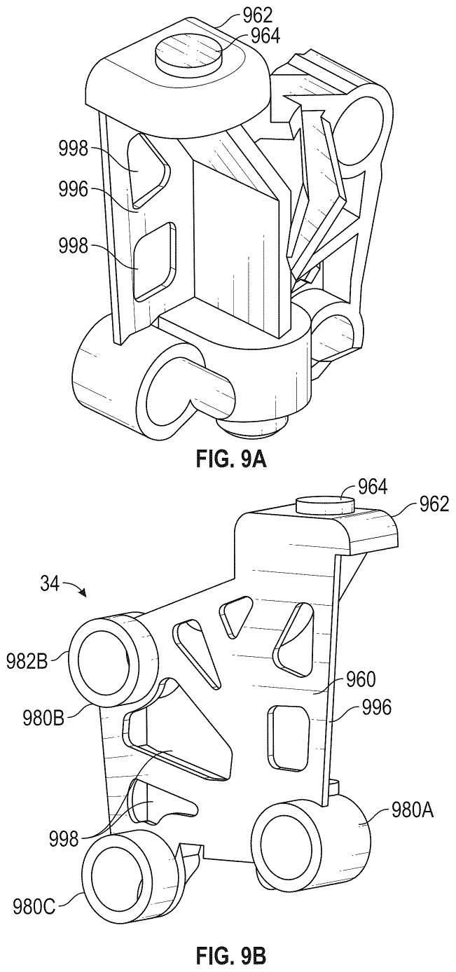

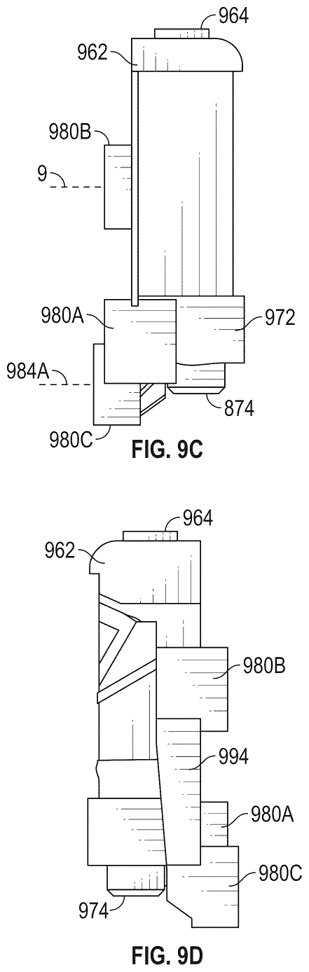

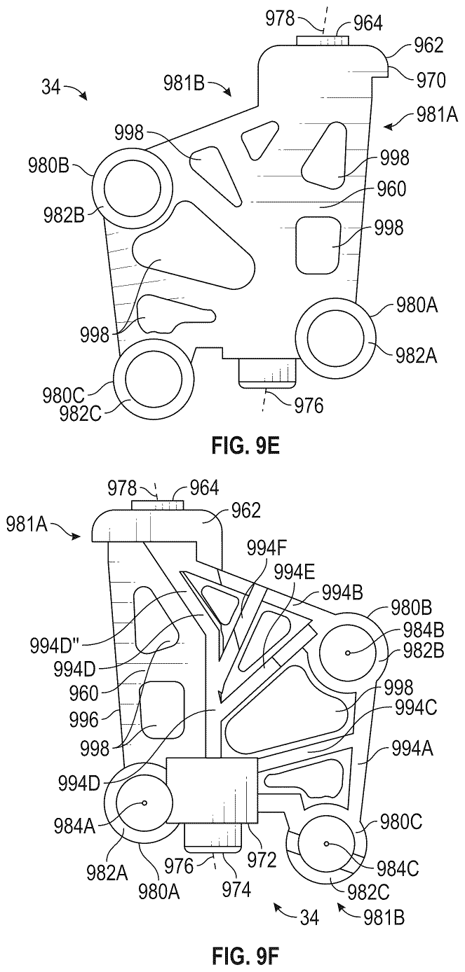

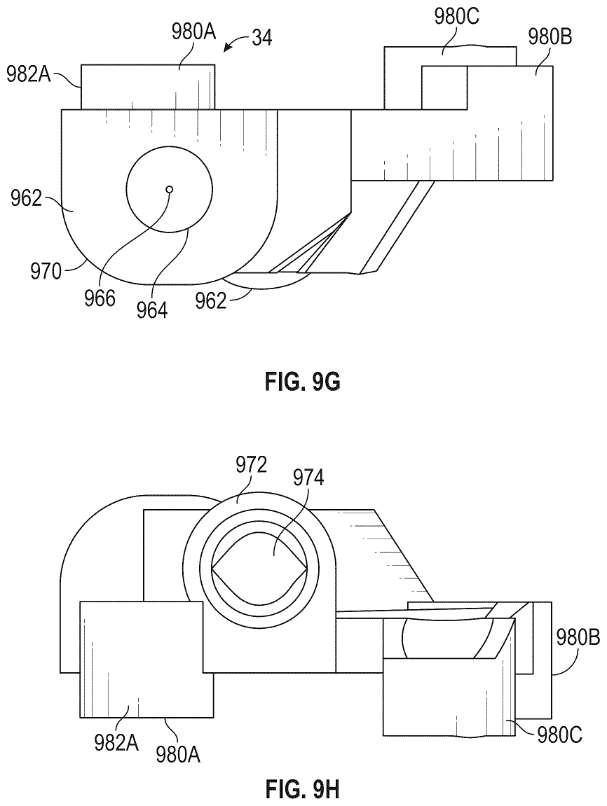

Referring now to FIGS. 9A-9H, various views of the left intermediate bracket 34 are illustrated. A planar base 960 is illustrated. The planar base 960 may be made of continuous material or may have portions that are cut out. From an engineering standpoint, having more of the planar base 960 cut out reduces the amount of weight of the intermediate bracket. However, enough of the planar base 960 is retained to provide strength based upon engineering analysis. The left intermediate bracket 34 has a top mounting extension 962. The top mounting extension 962 has a cylindrical extension 964 extending upwards therefrom. That is, in a vehicle setting, the extensions 964 may be in a horizontal in direction. The cylindrical extensions 964 have a longitudinal axis 966. The extensions 964 extend in a direction perpendicular to the general planar base 960. A pair of angular supports 968 extend diagonally between the extension 964 and the planar base 960. The supports 968 extend on a 45° angle. The extensions 964 are generally planar but have a curved or semi-circular edge.

The extension 964 extends to couple to one of the upper attachment bracket 36.

A lower mounting extension 972 has a lower extension 974 that is cylindrical and extends outward from the lower mounting extension 972. The lower mounting extension 972 extends in the same direction as the upper mounting extension 964. The lower extension 974 has an axis 976. The upper extension 964 and the lower extension 974 are parallel to each other and are both perpendicular to the planar base 960. The axis 976 is not colinear with or not aligned with the axis 966.

A dividing line 978 is an imaginary line that extends from the upper extension 864 to the lower extension 974 and forms two lateral sides of the bracket 34; a first lateral side 981A and a second lateral side 981B. The left intermediate bracket 34 has three housing mounts 980A, 980B and 980C. The housing mount 980A is disposed on the first side lateral side 981A of the dividing line 978. The housing mounts 980B and 980C are located on the second lateral side 981B of the dividing line 978 from the housing mount 980A. Each of the housing mounts 980A-980C are defined by cylindrical walls 982A, 982B and 982C, respectively. The cylindrical walls 982 have respective axes 984A, 984B and 984C. The axes 984A-984C are normal to or perpendicular from the planar base 960. The housing mounts 980A-980C are used for coupling to the housing 16D of the electric drive module 16.

Referring now to FIGS. 9A-9H, a plurality of ribs 994 are used to interconnect the housing mounts 980A-980C and the cylindrical walls 882A-882C with the top mounting extension 962 or the area thereby and the lower mounting extensions 972 or the area thereby.

A first rib 994A extends between the cylindrical walls 982B and 982C. A second rib 994B extends between the housing mount 980A and the cylindrical wall 982A and the area adjacent to the top mounting extension 962. A third rib 994C extends between the lower mounting extension 972 and the first rib 994A. That is, the end of the rib 994C is coupled between the cylindrical wall 982B and 982C at the rib 994A. An angled rib 994D extends vertically from the lower cylindrical extension 974 at a first portion 994D′ then angles at a second portion 994D″ toward the upper mounting extension 962. A fifth rib 994E extends between the first portion 994D′ and the housing mounting mount 980B and the cylindrical wall 982B. A sixth rib 994F extends between the first portion 994D′ of the fourth rib 994D and the second rib 994B.

The planar base 960 of this example extends between the first housing mount 980A and the area adjacent to the top mounting extension 962.

The intermediate brackets 32, 34 may be formed using DFSS processes. That is, the intermediate brackets 32, 34 may be modeled with software that optimizes the ribs, the rib positions and the number of openings 898 and 888 between the ribs 886 and 994.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Aspects of this disclosure may be implemented, in some embodiments, through a computer-executable program of instructions, such as program modules, generally referred to as software applications or application programs executed by an onboard vehicle computer or a distributed network of resident and remote computing devices. Software may include, in non-limiting examples, routines, programs, objects, components, and data structures that perform particular tasks or implement particular data types. The software may form an interface to allow a resident vehicle controller or control module or other suitable integrated circuit device to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network architectures, including multiprocessor systems, microprocessor-based or programmable-consumer electronics, minicomputers, mainframe computers, master-slave, peer-to-peer, or parallel-computation frameworks, and the like. In addition, aspects of the present disclosure may be practiced in distributed-computing environments where tasks are performed by resident and remote-processing devices that are linked through a communications network. In a distributed-computing environment, program modules or models may be located in both onboard and off-board computer-storage media including memory storage devices. Aspects of the present disclosure may therefore, be implemented in connection with various hardware, software or a combination thereof, in a computer system or other processing system.

Any of the methods described herein may include machine-readable instructions for execution by: (a) a processor, (b) a controller, and/or (c) any other suitable processing device. Any algorithm, software, control logic, protocol, or method disclosed herein may be embodied in software stored on a tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, there are many other methods for implementing the example machine readable instructions that may alternatively be used.

In this application, including the definitions below, the term “module,” the term “model,” or the term “controller” may be replaced with the term “circuit.” The term “module” or “model” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

What is claimed is:

1. A bracket assembly for an electric drive module having a drive module housing comprising:
a first intermediate bracket coupled to a first side of the housing;
a second intermediate bracket disposed on a second side of the housing;
a first cross member coupling the first intermediate bracket and the second intermediate bracket; and
a second cross member coupling the first intermediate bracket and the second intermediate bracket,
said first intermediate bracket and the second intermediate bracket, each comprising:
a planar base;
a top mounting extension perpendicular to the base in a first direction, the top mounting extension comprising a cylindrical extension extending therefrom;
a bottom mounting extension perpendicular to the base in the first direction; and
a plurality of housing mounts extending perpendicular to the base,
a plurality of ribs coupling the plurality of housing mounts, the top mounting extension and the bottom mounting extension.

2. The bracket assembly of claim 1 wherein the base comprises a plurality of openings extending therethrough.

3. The bracket assembly of claim 2 wherein the openings are disposed between at least two ribs of the plurality of ribs.

4. The bracket assembly of claim 1 wherein the plurality of ribs extends outward from the base.

5. The bracket assembly of claim 1 wherein the plurality of ribs extends in the first direction from the base.

6. The bracket assembly of claim 1 further comprising a support angularly disposed between the top mounting extension and the base.

7. The bracket assembly of claim 1 wherein the top mounting extension comprises a first cylindrical extension and the bottom mounting extension comprises a second cylindrical extension.

8. The bracket assembly of claim 7 wherein the first cylindrical extension comprises a first longitudinal axis and the second cylindrical extension comprises a second longitudinal axis, not aligned with the first longitudinal axis.

9. The bracket assembly of claim 1 wherein the plurality of housing mounts comprise a first housing mount disposed on a first side lateral side and a second housing mount disposed on a second lateral side, wherein the first lateral side and the second lateral side are defined by a line between the first mounting extension and the second mounting extension.

10. The bracket assembly of claim 9 wherein the first housing mount comprises a cylindrical channel normal to the planar base.

11. A vehicle comprising:
an electric drive module comprising a motor, a transmission, power electronics and a housing, the housing having the motor and transmission therein,
the bracket assembly of claim 9 coupling the first housing mount, the second housing mount and a third housing mount disposed on the second lateral side.

12. The vehicle of claim 11 further comprising an engine mount coupled to the top mounting extension.

13. The vehicle of claim 12 further comprising a cradle coupled to the bottom mounting extension.

14. The bracket assembly of claim 1 wherein the plurality of ribs comprises an angled rib extending between the top mounting extension and the bottom mounting extension.

15. The bracket assembly of claim 14 further comprising a second rib extending between the top mounting extension and a first housing mount of the plurality of housing mounts.

16. The bracket assembly of claim 15 further comprising a third rib extending between the first housing mount of the plurality of housing mounts and a second housing mount of the plurality of housing mounts.

17. The bracket assembly of claim 16 further comprising a fourth rib extending between the bottom mounting extension and the third rib.

18. The bracket assembly of claim 1 wherein the plurality of ribs comprises a first rib extending between the top mounting extension and the bottom mounting extension.

19. The bracket assembly of claim 18 wherein the plurality of ribs comprises a first rib extending between the top mounting extension and a first housing mount and a second rib extending between the first housing mount.

20. The bracket assembly of claim 19 wherein the plurality of ribs comprises a third rib extending between the top mounting extension and a second housing mount, a fourth rib extending between the second housing mount and the bottom mounting extension and a fifth rib between the fourth rib and a third housing mount.
